(19) United States
(12) Patent Application Publication
(10) Pub. No.: US 2025/0284514 A1
(43) Pub. Date: Sep. 11, 2025

(54) ENHANCED VIRTUAL PROTECTION, AUTOMATION, AND CONTROL SYSTEM OPERATION AND MANAGEMENT FOR POWER SUBSTATIONS

(71) Applicant: GE Infrastructure Technology LLC, Greenville, SC (US)

(72) Inventors: Balakrishna PAMULAPARTHY, Hyderabad (IN); Mitalkumar KANABAR, Markham (CA); Ilia VOLOH, Markham (CA); David MACDONALD, Barcelona (ES)

(73) Assignee: GE Infrastructure Technology LLC, Greenville, SC (US)

(21) Appl. No.: 18/598,928

(22) Filed: Mar. 7, 2024

(51) Int. Cl. G06F 9/455

(52) U.S. Cl. CPC G06F 9/45558; G06F 2009/45591; G06F 2009/45595

(57) ABSTRACT

Systems and methods for virtualizing power substations may include virtual protection, automation, and control (VPAC) system including a first physical server including first virtual machines, the first virtual machines including a first virtual machine representing a first physical component of a power substation, a second virtual machine representing a backup of the first virtual machine, and a third virtual machine configured to evaluate a health of the first physical server; and a second physical server including second virtual machines, the second virtual machines including a fourth virtual machine representing a backup to the first virtual machine, a fifth virtual machine representing a backup to the second virtual machine, and a sixth virtual machine configured to evaluate a health of the second physical server.

This disclosure generally relates to virtualization of power substations.

### BACKGROUND

Some power substations use separate hardware for different applications. Virtualization of power substations for both information technology and operational technology may be beneficial.

### SUMMARY

A virtual protection, automation, and control (VPAC) system for power substations may include a first physical server comprising first virtual machines, the first virtual machines comprising a first virtual machine representing a first physical component of a power substation, a second virtual machine representing a backup of the first virtual machine, and a third virtual machine configured to evaluate a health of the first physical server; and a second physical server comprising second virtual machines, the second virtual machines comprising a fourth virtual machine representing a backup to the first virtual machine, a fifth virtual machine representing a backup to the second virtual machine, and a sixth virtual machine configured to evaluate a health of the second physical server.

A virtual protection, automation, and control (VPAC) system for power substations may include first virtual machines operating on a first physical server, the first virtual machines comprising a first virtual machine representing a first physical component of a power substation, a second virtual machine representing a backup of the first virtual machine; and second virtual machines operating on a second physical server, the second virtual machines comprising a third virtual machine representing a backup to the first virtual machine, a fourth virtual machine representing a backup to the second virtual machine.

A virtual protection, automation, and control (VPAC) system for power substations may include a first physical server comprising first virtual machines, the first virtual machines comprising a first virtual machine representing a first physical component of a power substation, a second virtual machine representing a backup of the first virtual machine, a third virtual machine representing a second physical component of the power substation, and a fourth virtual machine representing a backup of the third virtual machine; and a second physical server comprising second virtual machines, the second virtual machines comprising a fifth virtual machine representing a backup to the first virtual machine, a sixth virtual machine representing a backup to the second virtual machine, a seventh virtual machine representing a backup of the third virtual machine, and an eighth virtual machine representing a backup of the fourth virtual machine.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is an example diagram representing virtualization of power substation physical components in accordance with one embodiment of the present disclosure.

FIG. 2 is an example virtual power substation architecture in accordance with one embodiment of the present disclosure.

FIG. 3 is an example virtual protection, automation, and controls system architecture in accordance with one embodiment of the present disclosure.

FIG. 4 is a diagram illustrating an example of a computing system that may be used in implementing embodiments of the present disclosure.

Certain implementations will now be described more fully below with reference to the accompanying drawings, in which various implementations and/or aspects are shown. However, various aspects may be implemented in many different forms and should not be construed as limited to the implementations set forth herein; rather, these implementations are provided so that this disclosure will be thorough and complete, and will fully convey the scope of the disclosure to those skilled in the art. Like numbers in the figures refer to like elements throughout. Hence, if a feature is used across several drawings, the number used to identify the feature in the drawing where the feature first appeared will be used in later drawings.

### DETAILED DESCRIPTION

Many critical infrastructure assets, such as power plants, transmission and distribution networks, transportation systems and water processing plants, are efficiently and safely operated using control systems. Such control systems act as the “brains” of the plant or asset reading information from sensors and sending command signals to actuators. Control systems are also critical subsystems in mobile assets such as aircraft, automobiles and even locomotives. However, these same critical control systems are now the focus of sophisticated cyber-attacks.

In modern power substations, intelligent systems like human-machine interfaces (HMI), supervisory control and data acquisition (SCADA), remote terminal units (RTU) gateways, and firewalls are used. In many substations, there may be a separate device (e.g., hardware) for each of those applications. In general, the single devices are performing one task each.

Virtualization is a technology that allows for creating useful services and applications using resources traditionally tied to specific hardware. Therefore, virtualization allows for consolidating all the hardware onto a virtualized platform. Through virtualization, utility infrastructure owners can adopt white-box gateways and servers and implement them in a redundant system for high-availability purpose. This virtualization practice has been adopted in the IT (information technology) domain for a while, and now it has extended into the OT (operational technology) world.

The present disclosure proposes a unique virtualization architecture for digital substations, ensuring redundancy and at the same time managing operations uniquely with virtualization environment benefits. Using virtualization in power substations allows for not only reducing the number of different boxes and hardware in the substation, but also achieves targeted operations in a different and effective manner.

Utilities are beginning to recognize the need for optimizing and modernizing substations by building more intelligence at the edge. As an increasing number of sensors generate more data, greater processing power at the edge (e.g., substation) is a key needed to unlock the ability to continually analyze and act upon this overwhelming volume of information with minimal latency. The journey to modern substation architecture starts with leveraging standardized, commercial, IEC-61850-3 certified commercial-off-the-shelf (COTS) ruggedized server hardware for the substations, and implementing software-defined automation and control systems. Multiple substation workloads can be virtualized and consolidated onto a single platform, making management of these workloads easier as proposed below.

In recent years, utility plant owners have been investigating opportunities and strategies to bring intelligence into substations to enable smart grid paradigm. In a typical digitalized substation, robust embedded computing gateways/IEDs with high-performance compute, networking and storage have been integrated to enable control and monitoring of substations. Intelligent HMIs (human-machine interfaces) terminals and protocol-authenticating servers are used to enable communications. All these have contributed to the increasing complexity and footprint of SCADA and PAC management in substations. This invention solves these challenges and proposes and novel and unique architecture for digital substation operation and management using VPAC (virtual protection, automation, and control).

Current substation architecture may be outdated and inflexible. Distributed Energy Resources (DERs), which could make the grid more resilient to these impacts, cannot be orchestrated using existing technology. The vast amounts of data that can be generated by the grid is not easily collected and shared across the landscape. This limit centralized management systems, and makes it challenging for operators to accurately estimate and react to the changes in electricity demand as well as to minimize disruption during extreme weather events.

Legacy substation technology is built on thousands of fixed-function devices that cannot easily protect and control two-way flows of electricity within substations. They also will not provide value to leverage for future grid solutions such as blockchain transacted energy and packetized energy management. Installing, servicing, and upgrading these fixed-function devices is also very expensive and time consuming. And meeting NERC CIP compliance standards is still a painstaking and error-prone manual process.

Utilities have taken a step towards a smarter grid by virtualizing critical grid management applications within the control center, using VMware Cloud Foundation and North American Electric Reliability Corporation Critical Infrastructure Protection (NERC CIP) compliant designs. There is an opportunity to extend that capability into modernizing substations with the availability of IEC-61850-3 certified servers built for substations and hypervisor supporting latency-sensitive workloads in the substation.

Modern substations require standardized, flexible, scalable, and secure systems to build a data-driven power grid to improve the local decisions being made in real time (RT) and manage instabilities caused by fluctuating demand and generation imbalances over a wide area-all while remaining secure, resilient, and easy to manage. Modernizing the legacy command-and-control infrastructure within power substations, switchyards, and generation facilities today is a massive undertaking.

The proposed virtualization architecture here may initially reduce substation downtime. In addition to a more resilient grid, utilities gain the following benefits from virtualized edge compute: (1) Connect their control center(s) to their edge substations, switchyards, and generation facilities and manage them with a common set of tools. (2) Reduce CAPEX due to labour reductions with hardware consolidation and reduce OPEX due to labor reductions and lower maintenance overhead. (3) Simplify installation, maintenance, and future upgrading of utility workloads while making work environments safer by minimizing the number of dangerous touchpoints. (4) Streamline NERC-CIP compliance with increased access to data and smaller physical networks.

In one or more embodiments, each virtual machine (VM) may host virtual protection relay (VPR) functions with critical and non-critical function categories. VPR may be considered as equivalent to a digital protection relay hardware (or bay control unit, or substation gateway hardware). The critical and non-critical functions may be isolated (e.g., interrupt request off-loading). In each server, one dedicated VM may receive all health monitoring data of different categories, and may use the data to compute a server health index (e.g., a scale of 1-5 with 5 being worst). The server health index may be based on ambient temperature data, server design specifications, operating conditions, server criticality, server security, server communications, server time synchronization, and the like. Each VM may include a hot-standby backup VM within a same server, and each server may include a hot-standby backup server by which each VM may have quadruple redundancy. A second VM within a same server may act as a backup in case a first VM is down, following by first and second VMs in a different server. A backup sequence and priority of backup VMs may be based on a sequence and priority of VMs set by a user, for example. Within a same server, generic object oriented substation event (GOOSE) messages between VMs may between VMs may be communicated using intra-VM communications at a hypervisor level and between two servers. GOOSE messages between VMs may be communicated using inter-VM communications at a network interface controller (NIC) level. Both servers may receive power SV data published on a process bus. Only one server may communicate data to a main/remote center, while the other server may communicate control commands from VMs to a switchgear to optimize the communication bandwidth/latency and isolate one server to only interact with an OT network. Within each server, both VMs may run critical and non-critical functions, but only one VM may communicate data/information related to critical functions and non-critical functions to reduce the traffic. Both the servers may be modelled as digital twins in terms of operations, communications, cybersecurity, and configurations so that any deviations in the parameters against another server from a common baseline may be identified (e.g., as a system for cross-domain identity management event). Because one server may only connect to the OT, it may be able to identify any performance deviations in the other server connected to the IT in terms of cybersecurity issues.

Using virtualization with digital twin modeling in power substations may both reduce the hardware in the substation and improve reliability and security of substation operations (e.g., by monitoring both IT and OT data while maintaining separation of IT and OT environments).

The above descriptions are for purposes of illustration and are not meant to be limiting. Numerous other examples, configurations, processes, etc., may exist, some of which are described in greater detail below. Example embodiments will now be described with reference to the accompanying figures.

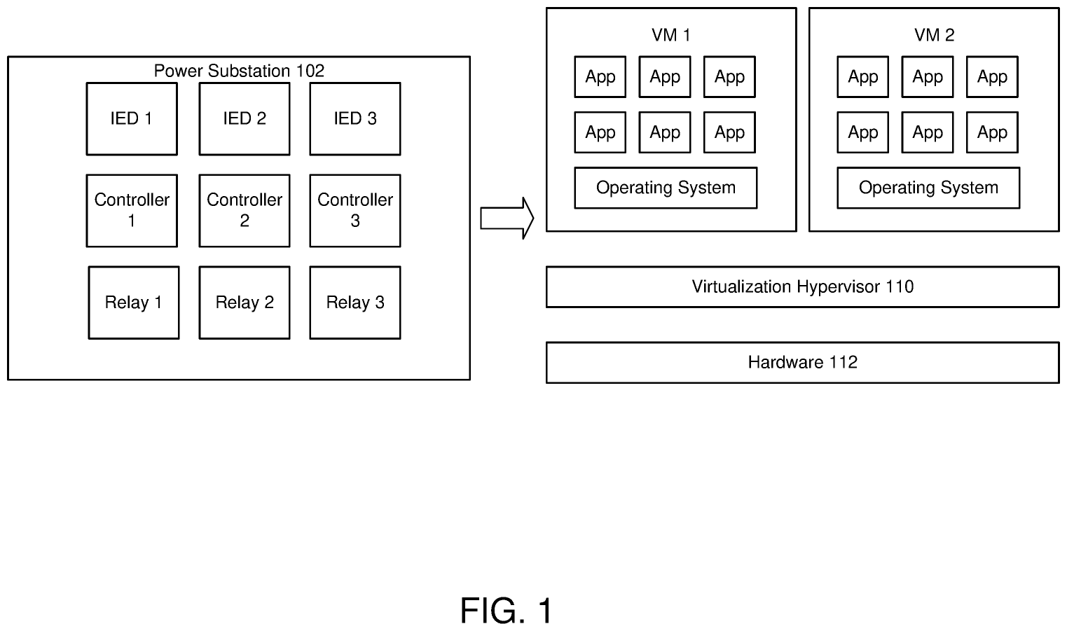

FIG. 1 is an example diagram representing virtualization of power substation physical components in accordance with one embodiment of the present disclosure.

Referring to FIG. 1, power substation physical components 102 (e.g., intelligent electronic devices, controllers, relays, etc.) may be modeled as virtual (e.g., software) devices at virtual machines (e.g., VM1 and VM2). For example, any of the power substation physical components 102 may be represented as a software application (e.g., “app” as shown) in a VM, and may be duplicated so that the component is represented by an app in both VM1 and VM 2. Both VM1 and VM2 may include an operating system. The VMs may be isolated at a hypervisor level (e.g., via a virtualization hypervisor 110), and may use hardware 112 (e.g., storage, compute resources, memory, network resources, etc.).

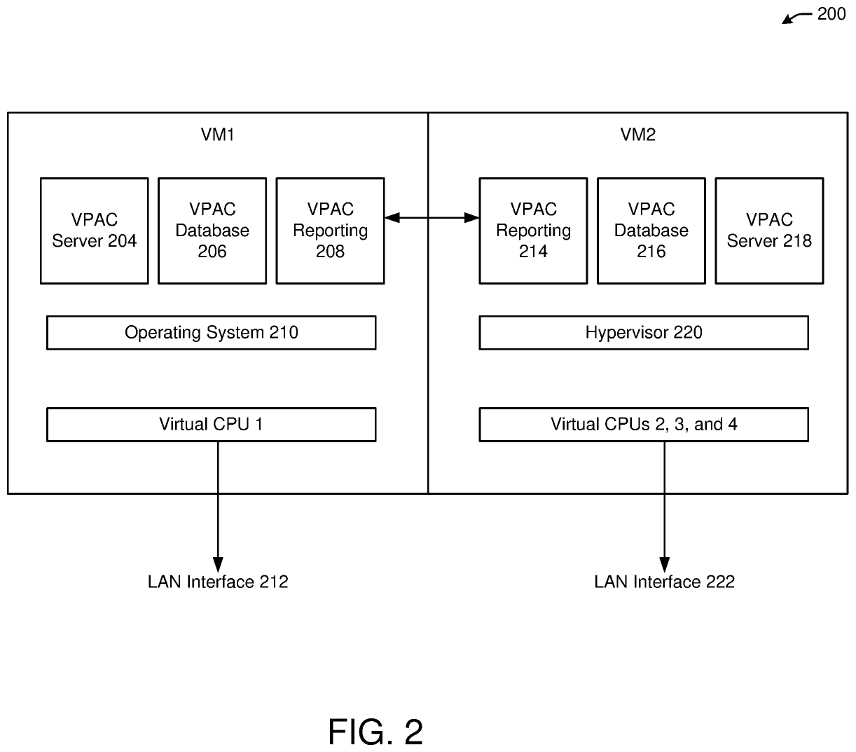

FIG. 2 is an example virtual power substation architecture 200 in accordance with one embodiment of the present disclosure.

Referring to FIG. 2, the virtual power substation architecture 200 may include a VM1 and a VM2 in communication with each other at an intra-VM communication level and an inter-VM communication level (e.g., across servers). VM1 may include a VPAC server 204, a VPAC database 206, VPAC reporting 208, an operating system 210, and a virtual central processing unit (CPU 1), which may communicate with a local area network (LAN) interface 212. VM2 may include VPAC reporting 214 (e.g., which may use intra-VM communications to share VPAC data with the VPAC reporting 208), a VPAC database 216, a VPAC server 218, a hypervisor 220, virtual CPUs (e.g., virtual CPUs 2, 3, and 4), and a LAN interface 222 for inter-VM communications.

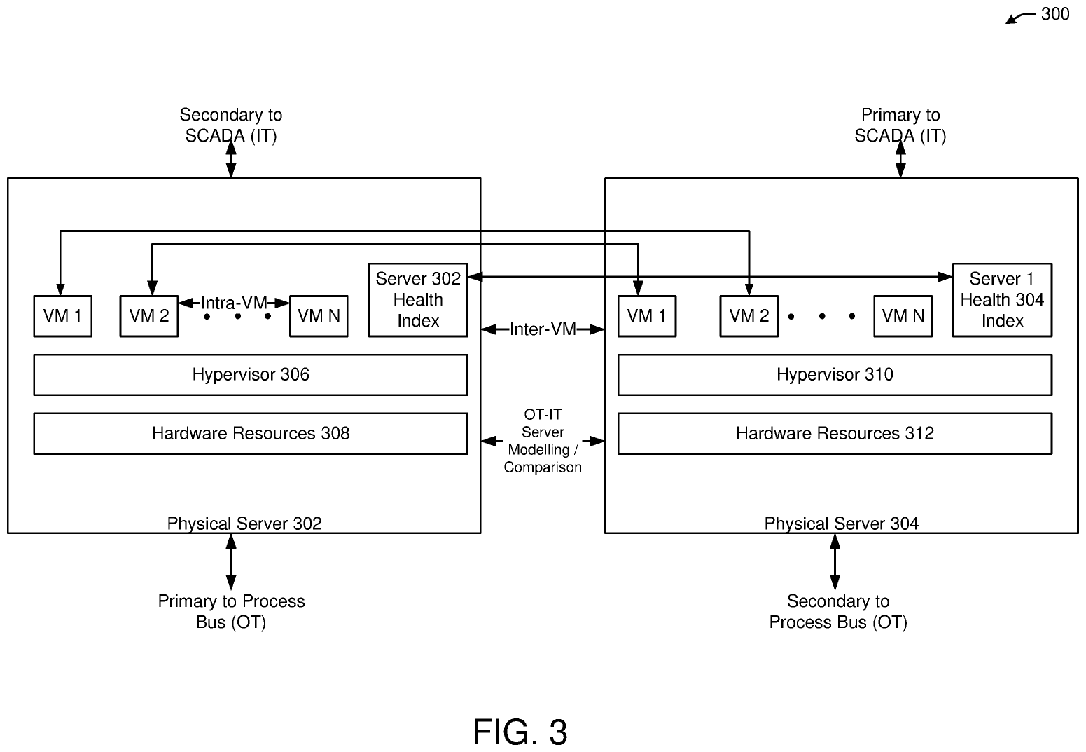

FIG. 3 is an example virtual protection, automation, and controls (VPAC) system architecture 300 in accordance with one embodiment of the present disclosure.

Referring to FIG. 3, the VPAC system architecture 300 may include a physical server 302 and a physical server 304, each with redundant VMs. For example, the physical server 302 may include VM1, VM2, . . . , VM N for N VMs, and the physical server 304 may include VM1, VM2, . . . , VM N for N VMs serving as duplicates of the VMs in the physical server 302. In each server, a dedicated VM may receive all the health monitoring data of different categories for the server (e.g., ambient temperature data, etc.) and may use that data to compute a server health index (e.g., server 302 health index, server 304 health index). The physical server 302 may include a hypervisor 306 and hardware resources 308 (e.g., storage resources, compute resources, memory resources, network resources, etc.). The physical server 304 may include a hypervisor 310 and hardware resources 312 (e.g., storage resources, compute resources, memory resources, network resources, etc.). The physical server 302 may include a primary connection to a physical bus (e.g., for OT connection) and a secondary connection to SCADA (e.g., for IT connection). The physical server 304 may include a primary connection to SCADA (e.g., for IT connection) and a secondary connection to a physical bus (e.g., for OT connection).

As shown in FIG. 3, each VM may have quadruple redundancy because each VM in a physical server may have a hot-standby backup VM within a same server (e.g., VM1 and VM2 in the physical server 302), and each server may have a hot-standby backup server (e.g., physical server 302 with physical server 304 as its hot-standby backup server).

In one or more embodiments, each VM may host VPR functions with critical and non-critical function categories. VPR may be considered as equivalent to a digital protection relay hardware. The critical and non-critical functions may be isolated (e.g., interrupt request off-loading). In each server, one dedicated VM may receive all health monitoring data of different categories, and may use the data to compute a server health index (e.g., a scale of 1-5 with 5 being worst). Within a same server, GOOSE messages between VMs may between VMs may be communicated using intra-VM communications at a hypervisor level and between physical servers 302 and 304. GOOSE messages between VMs may be communicated using inter-VM communications at a NIC level. Both physical servers 302 and 304 may receive power SV data published on a process bus. Only one server may communicate data to a main/remote center, while the other server may communicate control commands from VMs to a switchgear to optimize the communication bandwidth/latency and isolate one server to only interact with an OT network. Within each server, both VMs may run critical and non-critical functions, but only one VM may communicate data/information related to critical functions and non-critical functions to reduce the traffic. Both the physical servers 302 and 304 may be modelled as digital twins in terms of operations, communications, cybersecurity, and configurations so that any deviations in the parameters against another server from a common baseline may be identified (e.g., as a system for cross-domain identity management event). Because one server may only connect to the OT, it may be able to identify any performance deviations in the other server connected to the IT in terms of cybersecurity issues.

It is understood that the above descriptions are for purposes of illustration and are not meant to be limiting.

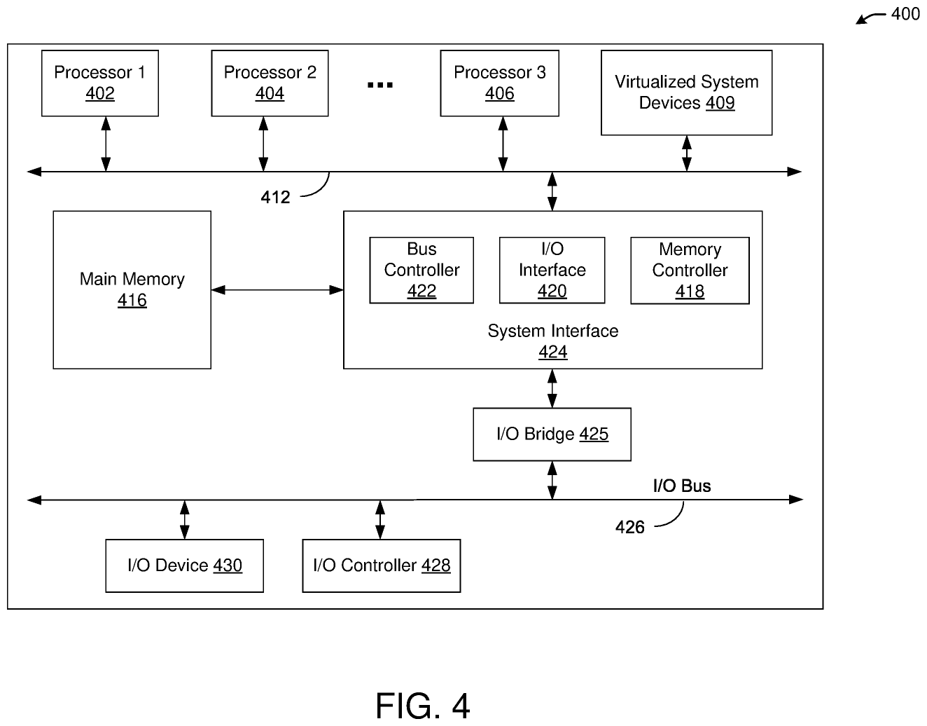

FIG. 4 is a diagram illustrating an example of a computing system 400 that may be used in implementing embodiments of the present disclosure.

The computer system 400 (system) includes one or more processors 402-406 and virtualized system devices 409 (e.g., representing at least a portion of FIG. 1, FIG. 2, and/or FIG. 3). Processors 402-406 may include one or more internal levels of cache (not shown) and a bus controller 422 or bus interface unit to direct interaction with the processor bus 412. Processor bus 412, also known as the host bus or the front side bus, may be used to couple the processors 402-406 with the system interface 424. System interface 424 may be connected to the processor bus 412 to interface other components of the system 400 with the processor bus 412. For example, system interface 424 may include a memory controller 418 for interfacing a main memory 416 with the processor bus 412. The main memory 416 typically includes one or more memory cards and a control circuit (not shown). System interface 424 may also include an input/output (I/O) interface 420 to interface one or more I/O bridges 425 or I/O devices with the processor bus 412. One or more I/O controllers and/or I/O devices may be connected with the I/O bus 426, such as I/O controller 428 and I/O device 430, as illustrated.

I/O device 430 may also include an input device (not shown), such as an alphanumeric input device, including alphanumeric and other keys for communicating information and/or command selections to the processors 402-406. Another type of user input device includes cursor control, such as a mouse, a trackball, or cursor direction keys for communicating direction information and command selections to the processors 402-406 and for controlling cursor movement on the display device.

System 400 may include a dynamic storage device, referred to as main memory 416, or a random access memory (RAM) or other computer-readable devices coupled to the processor bus 412 for storing information and instructions to be executed by the processors 502-506. Main memory 416 also may be used for storing temporary variables or other intermediate information during execution of instructions by the processors 402-406. System 400 may include a read only memory (ROM) and/or other static storage device coupled to the processor bus 412 for storing static information and instructions for the processors 402-406. The system outlined in FIG. 4 is but one possible example of a computer system that may employ or be configured in accordance with aspects of the present disclosure.

According to one embodiment, the above techniques may be performed by computer system 400 in response to processor 404 executing one or more sequences of one or more instructions contained in main memory 416. These instructions may be read into main memory 416 from another machine-readable medium, such as a storage device. Execution of the sequences of instructions contained in main memory 416 may cause processors 402-406 to perform the process steps described herein. In alternative embodiments, circuitry may be used in place of or in combination with the software instructions. Thus, embodiments of the present disclosure may include both hardware and software components.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Program module(s), applications, or the like disclosed herein may include one or more software components including, for example, software objects, methods, data structures, or the like. Each such software component may include computer-executable instructions that, responsive to execution, cause at least a portion of the functionality described herein (e.g., one or more operations of the illustrative methods described herein) to be performed.

A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform.

Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, or a report writing language. In one or more example embodiments, a software component comprising instructions in one of the foregoing examples of programming languages may be executed directly by an operating system or other software component without having to be first transformed into another form.

A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

Software components may invoke or be invoked by other software components through any of a wide variety of mechanisms. Invoked or invoking software components may comprise other custom-developed application software, operating system functionality (e.g., device drivers, data storage (e.g., file management) routines, other common routines and services, etc.), or third-party software components (e.g., middleware, encryption, or other security software, database management software, file transfer or other network communication software, mathematical or statistical software, image processing software, and format translation software).

Software components associated with a particular solution or system may reside and be executed on a single platform or may be distributed across multiple platforms. The multiple platforms may be associated with more than one hardware vendor, underlying chip technology, or operating system. Furthermore, software components associated with a particular solution or system may be initially written in one or more programming languages, but may invoke software components written in another programming language.

Computer-executable program instructions may be loaded onto a special-purpose computer or other particular machine, a processor, or other programmable data processing apparatus to produce a particular machine, such that execution of the instructions on the computer, processor, or other programmable data processing apparatus causes one or more functions or operations specified in any applicable flow diagrams to be performed. These computer program instructions may also be stored in a computer-readable storage medium (CRSM) that upon execution may direct a computer or other programmable data processing apparatus to function in a particular manner, such that the instructions stored in the computer-readable storage medium produce an article of manufacture including instruction means that implement one or more functions or operations specified in any flow diagrams. The computer program instructions may also be loaded onto a computer or other programmable data processing apparatus to cause a series of operational elements or steps to be performed on the computer or other programmable apparatus to produce a computer-implemented process.

Additional types of CRSM that may be present in any of the devices described herein may include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile disc (DVD) or other optical storage, magnetic cassettes, magnetic tape, magnetic disk storage or other magnetic storage devices, or any other medium which can be used to store the information and which can be accessed. Combinations of any of the above are also included within the scope of CRSM. Alternatively, computer-readable communication media (CRCM) may include computer-readable instructions, program module(s), or other data transmitted within a data signal, such as a carrier wave, or other transmission. However, as used herein, CRSM does not include CRCM.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

What is claimed is:

1. A virtual protection, automation, and control (VPAC) system for power substations, the VPAC system comprising:
a first physical server comprising first virtual machines, the first virtual machines comprising a first virtual machine representing a first physical component of a power substation, a second virtual machine representing a backup of the first virtual machine, and a third virtual machine configured to evaluate a health of the first physical server; and
a second physical server comprising second virtual machines, the second virtual machines comprising a fourth virtual machine representing a backup to the first virtual machine, a fifth virtual machine representing a backup to the second virtual machine, and a sixth virtual machine configured to evaluate a health of the second physical server.

2. The VPAC system of claim 1, wherein one of the first physical server or the second physical server connects to an information technology (IT) network while the other of the first physical server or the second physical server connects to an operational technology (OT) network to isolate OT network traffic from IT network traffic.

3. The VPAC system of claim 2, further comprising digital twins virtually modeling the one of the first physical server or the second physical server connecting to the IT network and the other of the first physical server or the second physical server connecting to the OT network, wherein one of the first physical server or the second physical server connecting to the IT network is disconnected from an external network connection based on detection, by the other of the first physical server or the second physical server connecting to the OT network, of a deviation of the IT network traffic from operation criteria.

4. The VPAC system of claim 1, wherein the first physical server comprises a first hypervisor, wherein the second physical server comprises a second hypervisor, wherein the first virtual machine and the second virtual machine communicate using the first hypervisor, and wherein the fourth virtual machine and the fifth virtual machine communicate using the second hypervisor.

5. The VPAC system of claim 1, wherein the first physical server and the second physical server communicate with each other at a network interface controller level.

6. The VPAC system of claim 1, further comprising a seventh virtual machine representing a second physical component of the power substation and an eighth virtual machine representing a backup of the seventh virtual machine, and further comprising a ninth virtual machine representing a backup of the seventh virtual machine and a tenth virtual machine representing a backup of the eighth virtual machine.

7. The VPAC system of claim 6, wherein the first virtual machine represents first functions of the power substation, wherein the seventh virtual machine represents second functions of the power substation different than the first functions, and wherein an order of backup functionality for the first virtual machine comprises the fourth virtual machine and is based on a backup sequence and priority set by a user.

8. The VPAC system of claim 6, wherein only the first virtual machine of the first virtual machines communicates data associated with the first functions.

9. The VPAC system of claim 1, wherein the first virtual machines and the second virtual machines represent digital protection relay, bay control unit, or substation gateway hardware.

10. The VPAC system of claim 1, wherein the health of the first physical server and the health of the second physical server are based on ambient temperature data, design specifications of the first physical server and the second physical server, operating conditions of the first physical server and the second physical server, security of the first physical server and the second physical server, communications of the first physical server and the second physical server, and time synchronization of the first physical server and the second physical server.

11. The VPAC system of claim 1, wherein only the first virtual machine is configured to communicate data related to functions of the power substation, and wherein an order of backup functionality for the first virtual machine comprises the fourth virtual machine and is based on a backup sequence and priority set by a user.

12. The VPAC system of claim 1, wherein when the health of the first physical server exceeds a threshold criteria, the second physical server is configured to assume operations performed by the first physical server and to connect to both an IT network and an OT network until the health of the first physical server is below the threshold criteria.

13. A virtual protection, automation, and control (VPAC) system for power substations, the VPAC system comprising:
first virtual machines operating on a first physical server, the first virtual machines comprising a first virtual machine representing a first physical component of a power substation, a second virtual machine representing a backup of the first virtual machine; and
second virtual machines operating on a second physical server, the second virtual machines comprising a third virtual machine representing a backup to the first virtual machine, a fourth virtual machine representing a backup to the second virtual machine.

14. The VPAC system of claim 13, wherein one of the first physical server or the second physical server connects to an information technology (IT) network without direct connection to physical components of the power substation while the other of the first physical server or the second physical server connects to an operational technology (OT) network and controls operations of the physical components of the power substation, wherein the one of the first physical server or the second physical server connected to the IT network communicates, using secure private network-based inter-server communications, with the other of the first physical server or the second physical server connected to the OT network, and wherein when the one of the first physical server or the second physical server connected to the IT network is deactivated, the other of the first physical server or the second physical server connected to the OT network accesses the IT network and the OT network.

15. The VPAC system of claim 13, wherein the first virtual machines further comprise a fifth virtual machine representing a second physical component of the power substation and a sixth virtual machine representing a backup of the fifth virtual machine, and wherein the second virtual machines comprise a seventh virtual machine representing a backup of the fifth virtual machine and an eighth virtual machine representing a backup of the sixth virtual machine.

16. The VPAC system of claim 15 wherein the first virtual machine represents first functions of the power substation, and wherein the fifth virtual machine represents second functions of the power substation different than the first functions.

17. The VPAC system of claim 16, wherein only the first virtual machine of the first virtual machines communicates data associated with the first functions.

18. A virtual protection, automation, and control (VPAC) system for power substations, the VPAC system comprising:
a first physical server comprising first virtual machines, the first virtual machines comprising a first virtual machine representing a first physical component of a power substation, a second virtual machine representing a backup of the first virtual machine, a third virtual machine representing a second physical component of the power substation, and a fourth virtual machine representing a backup of the third virtual machine; and
a second physical server comprising second virtual machines, the second virtual machines comprising a fifth virtual machine representing a backup to the first virtual machine, a sixth virtual machine representing a backup to the second virtual machine, a seventh virtual machine representing a backup of the third virtual machine, and an eighth virtual machine representing a backup of the fourth virtual machine.

19. The VPAC system of claim 18, wherein one of the first physical server or the second physical server connects to an information technology (IT) network while the other of the first physical server or the second physical server connects to an operational technology (OT) network to isolate OT network traffic from IT network traffic.

20. The VPAC system of claim 18, wherein the first virtual machine represents first functions of the power substation, and wherein the third virtual machine represents second functions of the power substation different than the first functions.
